(19) United States
(12) Patent Application Publication
(10) Pub. No.: US 2015/0355310 A1
(43) Pub. Date: Dec. 10, 2015

(54) METROLOGY INSTRUMENT SYSTEM AND METHOD OF OPERATING

(71) Applicant: FARO Technologies, Inc., Lake Mary, FL (US)

(72) Inventors: Yu Gong, Oviedo, FL (US); Frederick John York, Longwood, FL (US)

(21) Appl. No.: 14/722,318

(22) Filed: May 27, 2015

Related U.S. Application Data
(60) Provisional application No. 62/008,569, filed on Jun. 6, 2014.

(51) Int. Cl. G01S 5/00; G01S 19/11; G01B 15/00

(52) U.S. Cl. CPC G01S 5/0036; G01B 15/00; G01S 19/11

(57) ABSTRACT

A system and method is provided for determining the geographic location of a three-dimensional metrology instrument. The three-dimensional metrology instrument includes a geographic location determination circuit, such as a GPS. The geographic location determination circuit allows the metrology instrument to synchronize the instruments internal clock to allow cooperative measurements with multiple metrology instruments. The geographic location determination circuit further allows for automatic localization of configuration parameters of the metrology instrument. The geographic location determination circuit still further allows for the recording of location when predetermined environmental events occur.

### CROSS-REFERENCE TO RELATED APPLICATIONS

The Present application is a Nonprovisional application of U.S. Provisional Application 62/008,569 entitled Metrology Instrument System and Method of Operation filed on Jun. 6, 2014, the content of which is incorporated by reference herein.

### BACKGROUND OF THE INVENTION

The present disclosure relates to a metrology instruments, and more particularly to a metrology instrument for measuring a three-dimensional coordinate of an object where the metrology instrument includes a location determination device.

Portable metrology instruments, such as portable articulated arm coordinate measuring machines (AACMMs), laser trackers, laser scanners, triangulation scanners and the like for example, have found widespread use in the manufacturing or production of parts where there is a need to rapidly and accurately verify the dimensions of the part during various stages of the manufacturing or production (e.g., machining). Portable metrology instruments represent an improvement over known stationary or fixed, cost-intensive and relatively difficult to use measurement installations, particularly in the amount of time it takes to perform dimensional measurements of relatively complex parts. Typically, a user of a portable metrology instrument simply guides a probe along the surface of the part or object to be measured. The measurement data are then recorded and provided to the user. In some cases, the data are provided to the user in visual form, for example, three-dimensional (3-D) form on a computer screen. In other cases, the data are provided to the user in numeric form, for example when measuring the diameter of a hole, the text “Diameter=1.0034” is displayed on a computer screen.

An example of a prior art portable articulated arm CMM is disclosed in commonly assigned U.S. Pat. No. 5,402,582 ('582), which is incorporated herein by reference in its entirety. The '582 patent discloses a 3-D measuring system comprised of a manually-operated articulated arm CMM having a support base on one end and a measurement probe at the other end. Commonly assigned U.S. Pat. No. 5,611,147 ('147), which is incorporated herein by reference in its entirety, discloses a similar articulated arm CMM. In the '147 patent, the articulated arm CMM includes a number of features including an additional rotational axis at the probe end, thereby providing for an arm with either a two-two-two or a two-two-three axis configuration (the latter case being a seven axis arm).

Accordingly, while existing metrology instruments are suitable for their intended purposes the need for improvement remains, particularly in providing a method and apparatus for determining the geographical location of the metrology instrument and performing functions based on the location.

### BRIEF DESCRIPTION OF THE INVENTION

In accordance with an embodiment a system for measuring three-dimensional (3D) coordinates of an object is provided. The system includes a first metrology instrument for measuring a first set of 3D coordinates of at least one point on a surface of the object in a local coordinate system frame of reference, the first metrology instrument having a first processor and a first system clock, wherein the first processor is configured in operation to synchronize the first system clock with a signal from an external source, wherein the signal includes at least a reference time data. A second metrology instrument is provided for measuring a second set of 3D coordinates of at least one point on the first metrology instrument in a second coordinate system frame of reference, the second metrology instrument having a second processor and a second system clock, wherein the second processor is configured in operation to synchronize the second system clock with the signal from the external source. A controller is operably coupled for communication to the first metrology instrument and the second metrology instrument, the controller including a processor responsive to executable computer instructions for determining a third set of 3D coordinates in the second coordinate system frame of reference of the at least one point on the object based at least in part on the first set of 3D coordinates and the second set of 3D coordinates.

In accordance with an embodiment, a method of measuring 3D coordinates of an object with multiple metrology devices. The method comprising: providing a first metrology instrument for measuring a first set of 3D coordinates of at least one point on a surface of the object, the first metrology instrument having a first processor, a first geographic location determination circuit and a first system clock; a second metrology instrument for measuring a second set of 3D coordinates of at least one point on the first metrology instrument, the second metrology instrument having a second processor, a second geographic location determination circuit and a second system clock; receiving with the first geographic location determination circuit a first signal from an external source; receiving with the second geographic location determination circuit the first signal from the external source; synchronizing the first system clock and the second system clock based at least in part on the signal; measuring with the first metrology instrument a first set of 3D coordinates of at least one point on the object in a local coordinate system frame of reference at a first time; measuring with the second metrology instrument a second set of 3D coordinates of at least one point on the first metrology instrument in a second coordinate system frame of reference at a second time; and determining a third set of 3D coordinates of the at least one point on the object in the second coordinate system frame of reference based at least in part on the first set of 3D coordinates, the second set of 3D coordinates, the first time and the second time.

In accordance with another embodiment, a method of configuring a 3D metrology instrument is provided. The method comprising: receiving a signal from an external source, the signal including data indicating a geographic location of the 3D metrology instrument; determining the geographic location of the 3D metrology instrument based on the signal; determining when localized settings are defined for the geographic location; retrieving the localized settings from memory; and changing the operation of the 3D metrology device instrument on the localized settings.

In accordance with an embodiment, a method of monitoring a 3D metrology instrument for predetermined events. The method comprising: providing a 3D metrology instrument having at least one sensor configured to measure an environmental condition the 3D metrology instrument having a geographic location determination circuit, a processor and memory; measuring a predetermined event with the sensor; determining the geographic location of the 3D metrology instrument with the geographic location determination circuit in response to measuring the predetermined event; and storing in the memory the measured predetermined event and the location of the 3D metrology instrument.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a portable articulated arm coordinate measuring machine (AACMM) in accordance with an embodiment of the invention;

FIG. 2 is a perspective view of a laser tracker in accordance with an embodiment of the invention;

FIG. 3 is a perspective view of a time-of-flight (TOF) laser scanner in accordance with an embodiment of the invention;

FIG. 4 is a perspective view of a triangulation scanner in accordance with an embodiment of the invention;

FIG. 5 is a block diagram of a 3D Instrument electronic data processing system accordance with another embodiment of the invention;

FIG. 6 is a block diagram of a metrology device having geographic location determination module in accordance with an embodiment of the invention;

FIG. 7 is a block diagram of a metrology device having geographic location determination module coupled an external antenna and arranged within a building in accordance with an embodiment of the invention;

FIG. 8 is a block diagram of a plurality of metrology devices, each having a geographic location determination module coupled to an external antenna;

FIG. 9 is a block diagram of a system using a GPS repeater to transmit GPS signals to one or more metrology devices arranged within a building; and

FIGS. 10-12 are flow diagrams of a method of operating the 3D Instruments of FIGS. 1-4 in accordance with an embodiment of the invention.

The detailed description explains embodiments of the invention, together with advantages and features, by way of example with reference to the drawings.

### DETAILED DESCRIPTION OF THE INVENTION

An embodiment of the present invention provides for the determination of a geographic location of a metrology device, such as an articulated arm coordinate measurement machine (AACMM), a laser tracker, a laser scanner or a triangulation scanner. Embodiments of the invention provide advantages in allowing the automatic configuration of 3D instrument parameters based on the geographic location. Embodiments of the invention provide advantages in allowing the automatic configuration of communications devices, such as wireless communications, to comply with local regulations based on the geographic location. Embodiments of the invention provide further advantages in determining where damage to the 3D instrument occurred. Embodiments of the invention allow for the automatic adjustment of leasing rates based on the location where the 3D Instrument is operated. Still further embodiments of the invention enable relatively accurate time synchronization among multiple instruments.

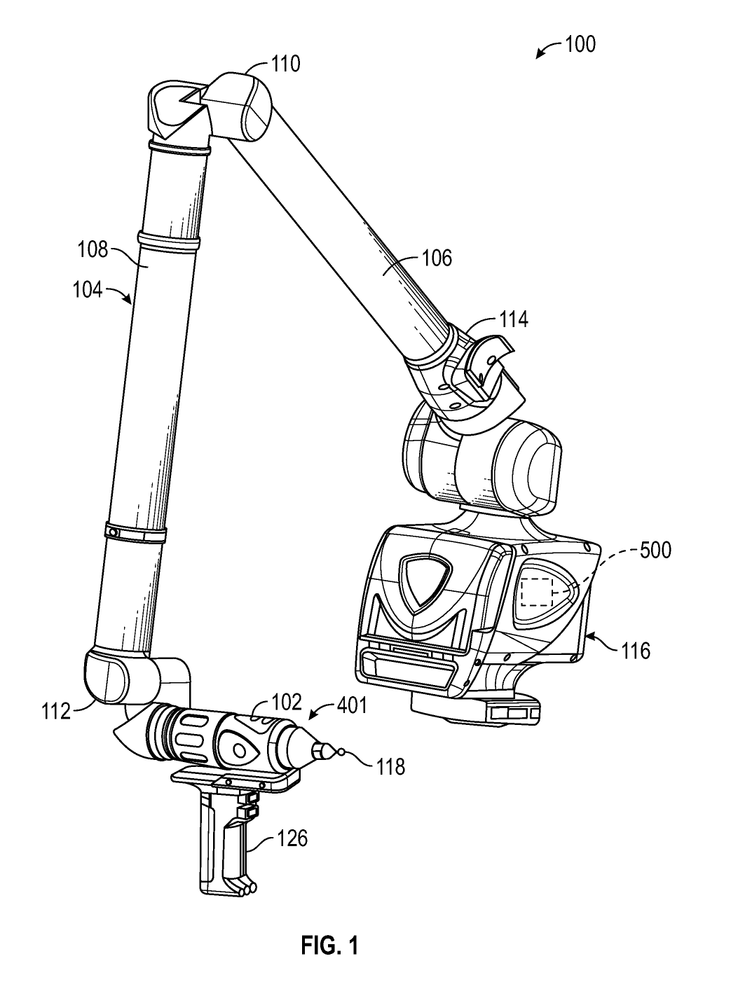

FIGS. 1-4 illustrate exemplary metrology instruments, including an articulated arm coordinate measurement (AACMM) device 100, a laser tracker device 200, a time-of-flight (TOF) laser scanner device 300 and a triangulation scanning device 400 (collectively referred to herein as 3D instruments) for example, according to various embodiments of the present invention. It should be appreciated that while embodiments herein may refer to specific 3D instruments, the claimed invention should not be so limited. In other embodiments, the various embodiments may be used in other 3D instruments, such as but not limited to laser line probes, total stations and theodolites for example.

Referring now to FIG. 1, an AACMM 100 according to various embodiments of the present invention, an articulated arm being one type of coordinate measuring machine. The AACMM 100 may be the same as that described in commonly owned U.S. Pat. No. 8,533,967 entitled “Coordinate Measurement Machine,” the contents of which are incorporated herein by reference. The exemplary AACMM 100 may comprise a six or seven axis articulated measurement device having a probe end 401 that includes a measurement probe housing 102 coupled to an arm portion 104 of the AACMM 100 at one end.

The arm portion 104 comprises a first arm segment 106 coupled to a second arm segment 108 by a rotational connection having a first grouping of bearing cartridges 110 (e.g., two bearing cartridges). A second grouping of bearing cartridges 112 (e.g., two bearing cartridges) couples the second arm segment 108 to the measurement probe housing 102. A third grouping of bearing cartridges 114 (e.g., three bearing cartridges) couples the first arm segment 106 to a base 116 located at the other end of the arm portion 104 of the AACMM 100. Each grouping of bearing cartridges 110, 112, 114 provides for multiple axes of articulated movement. Also, the probe end 401 may include a measurement probe housing 102 that comprises the shaft of the seventh axis portion of the AACMM 100 (e.g., a cartridge containing an encoder system that determines movement of the measurement device, for example a contact probe 118, in the seventh axis of the AACMM 100). In this embodiment, the probe end 401 may rotate about an axis extending through the center of measurement probe housing 102. In use the base 116 is typically affixed to a work surface.

Each bearing cartridge within each bearing cartridge grouping 110, 112, 114 typically contains an encoder system (e.g., an optical angular encoder system). The encoder system (i.e., transducer) provides an indication of the position of the respective arm segments 106, 108 and corresponding bearing cartridge groupings 110, 112, 114 that all together provide an indication of the position of the probe 118 with respect to the base 116 (and, thus, the position of the object being measured by the AACMM 100 in a certain frame of reference—for example a local or global frame of reference).

The probe 118 is detachably mounted to the measurement probe housing 102, which is connected to bearing cartridge grouping 112. A handle accessory 126 may be removable with respect to the measurement probe housing 102 by way of, for example, a quick-connect interface. In exemplary embodiments, the probe housing 102 houses a removable probe 118, which is a contacting measurement device and may have different tips 118 that physically contact the object to be measured, including, but not limited to: ball, touch-sensitive, curved and extension type probes. In other embodiments, the measurement is performed, for example, by a non-contacting device such as a laser line probe (LLP). In an embodiment, the handle 126 is replaced with the LLP using the quick-connect interface. Other types of accessory devices may replace the removable handle 126 to provide additional functionality. Examples of such accessory devices include, but are not limited to, one or more illumination lights, a temperature sensor, a thermal scanner, a bar code scanner, a projector, a paint sprayer, a camera, a video camera, an audio recording system or the like, for example.

In accordance with an embodiment, the base 116 of the portable AACMM 100 contains or houses an electronic data processing system that includes a base processing system that processes the data from the various encoder systems within the AACMM 100 as well as data representing other arm parameters to support three-dimensional (3-D) positional calculations, and resident application software that allows for relatively complete metrology functions to be implemented within the AACMM 100.

As will be discussed in more detail below, the electronic data processing system 500 in the base 116 may communicate with the encoder systems, sensors, and other peripheral hardware located away from the base 116 (e.g., a LLP that can be mounted to or within the removable handle 126 on the AACMM 100). The electronics that support these peripheral hardware devices or features may be located in each of the bearing cartridge groupings 110, 112, 114 located within the portable AACMM 100.

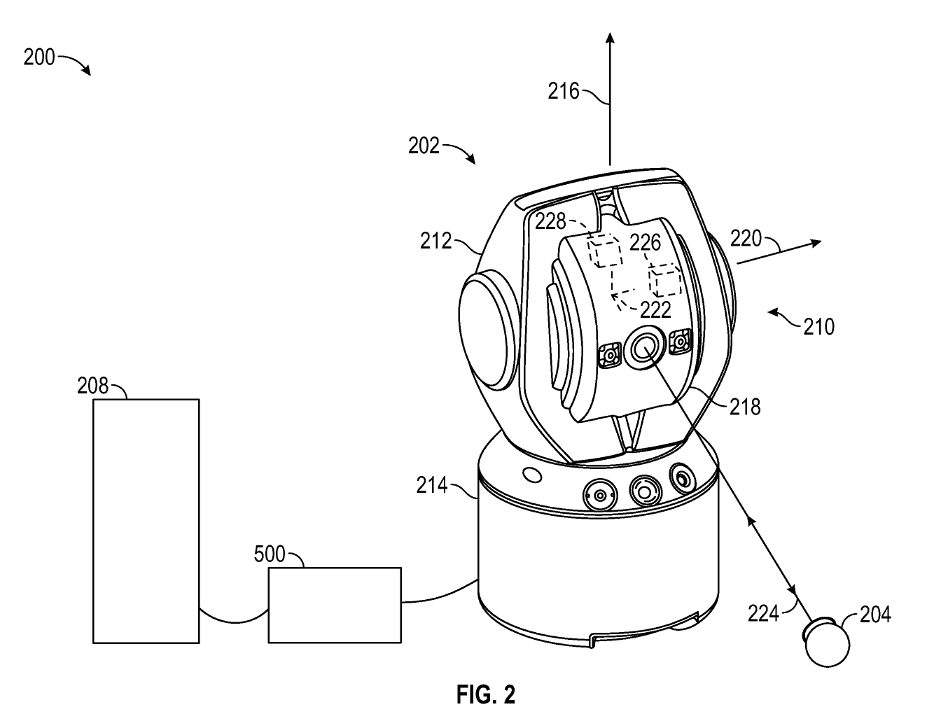

An exemplary laser tracker system 200 illustrated in FIG. 2 includes a laser tracker 202, a retroreflector target 204, an electronic data processing system 500, and an optional auxiliary computer 208. The laser tracker 200 may be similar to that described in commonly owned U.S. Provisional Application Ser. No. 61/842,572 filed on Jul. 3, 2013, the contents of which are incorporated herein by reference. It should be appreciated that while the electronic data processing system is illustrated external to the laser tracker 200, this is for exemplary purposes and the electronic data processing system 500 may be arranged within the housing of the laser tracker 200. An exemplary gimbaled beam-steering mechanism 210 of laser tracker 200 comprises a zenith carriage 212 mounted on an azimuth base 214 and rotated about an azimuth axis 216. A payload 218 is mounted on the zenith carriage 212 and rotated about a zenith axis 220. Zenith axis 220 and azimuth axis 216 intersect orthogonally, internally to tracker 200, at gimbal point 222, which is typically the origin of the local coordinate system frame of reference for distance measurements.

A laser beam 224 virtually passes through the gimbal point 222 and is pointed orthogonal to zenith axis 220. In other words, laser beam 224 lies in a plane approximately perpendicular to the zenith axis 220 and that passes through the azimuth axis 216. Outgoing laser beam 224 is pointed in the desired direction by rotation of payload 218 about zenith axis 220 and by rotation of zenith carriage 212 about azimuth axis 216. A zenith angular encoder 226, internal to the tracker 220, is attached to a zenith mechanical axis aligned to the zenith axis 220. An azimuth angular encoder 228, internal to the tracker, is attached to an azimuth mechanical axis aligned to the azimuth axis 216. The zenith and azimuth angular encoders 226, 228 measure the zenith and azimuth angles of rotation to relatively high accuracy. Outgoing laser beam 224 travels to the retroreflector target 204, which might be, for example, a spherically mounted retroreflector (SMR).

The distance to the retroreflector target 204 is determined by the electronic data processing system 500 in response to a signal from a measuring device, such as an absolute distance meter (ADM) or an interferometer for example. By measuring the radial distance between gimbal point 222 and retroreflector 204, the rotation angle about the zenith axis 220, and the rotation angle about the azimuth axis 216, the position of retroreflector 204 and thus the three-dimensional coordinates of the object being inspected is found by the electronic data processing system 500 within the local spherical coordinate system of the tracker.

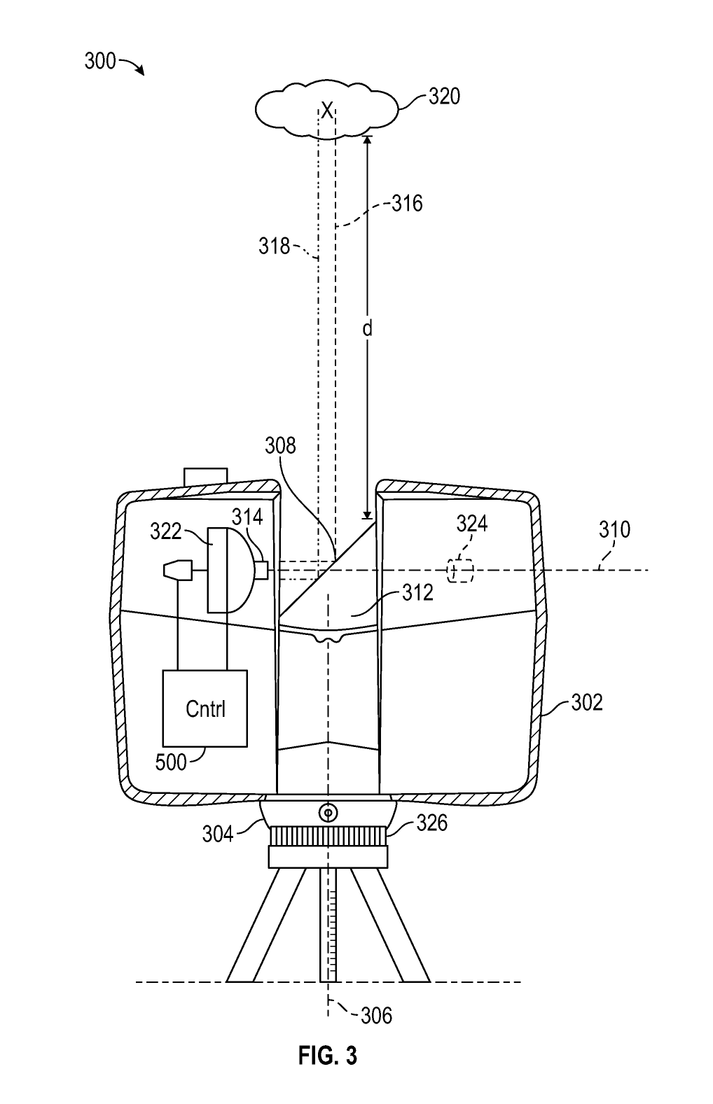

Referring now to FIG. 3, an exemplary laser scanner 300 is shown in accordance with embodiment of the invention. The laser scanner 300 has a measuring head 302 and a base 304. The laser scanner 300 may be similar to that described in commonly owned United States Patent Publication 2014/0078519 entitled “Laser Scanner,” the contents of which are incorporated by reference herein. The measuring head 302 is mounted on the base 304 such that the laser scanner 300 may be rotated about a vertical axis 306. In one embodiment, the measuring head 302 includes a gimbal point 308 that is a center of rotation about a vertical axis 306 and a horizontal axis 310. In an embodiment, the measuring head 302 has a rotary mirror 312, which may be rotated about a horizontal axis 310. The rotation about the vertical axis may be about the center of the base 304. In an embodiment, the vertical (azimuth) axis 306 and the horizontal (zenith) axis 310 intersect at the gimbal point 308, which may be an origin of a coordinate system.

The measuring head 302 is further provided with an electromagnetic radiation emitter, such as light emitter 314 for example, that emits an emitted light beam 316. In one embodiment, the emitted light beam 316 is coherent light, such as a laser beam for example. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 316 may be amplitude or intensity modulated, for example, with a sinusoidal waveform or with a rectangular waveform. The emitted light beam 316 is emitted by the light emitter 314 onto the rotary mirror 312, where it is deflected to the environment. A reflected light beam 318 is reflected from the environment by an object 320. The reflected or scattered light is intercepted by the rotary mirror 312 and directed into a light receiver 322. The directions of the emitted light beam 316 and the reflected light beam 318 result from the angular positions of the rotary mirror 312 and the measuring head 302 about the axis 306 and axis 310, respectively. These angular positions in turn depend on the rotary drives that cause rotations of the rotary mirror 312 and the measuring head 302 about the axis 310 and axis 306, respectively. Each of the axes 310, 306 include at least one angular transducer 324, 326 for measuring angle. The angular transducer may be an angular encoder.

Coupled to the light emitter 314 and the light receiver 322 is an electronic data processing system 500. The electronic data processing system 500 determines, for a multitude of surface points X, a corresponding number of distances “d” between the laser scanner 300 and surface points X on object 320. The distance to a particular surface point X is determined based at least in part on the speed of light in air through which electromagnetic radiation propagates from the device to the surface point X. In one embodiment the phase shift between the laser scanner 300 and the surface point X is determined and evaluated to obtain a measured distance “d”. In another embodiment, the elapsed time (the “time of flight” or TOF) between laser pulses is measured directly to determine a measured distance “d.”

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum “c” divided by the index of refraction. In other words, cₐᵢᵣ=c/n. A laser scanner of the type discussed herein is based on the time-of-flight of the light in the air (the round-trip time for the light to travel from the device to the object and back to the device). A method of measuring distance based on the time-of-flight of light (or any type of electromagnetic radiation) depends on the speed of light in air.

In an embodiment, the scanning of the volume about the laser scanner 300 takes place by quickly rotating the rotary mirror 312 about axis 310 while slowly rotating the measuring head 302 about axis 306, thereby moving the emitted light in a spiral pattern. For such a scanning system, the gimbal point 308 defines the origin of the local stationary reference system. The base 304 rests in a local stationary frame of reference.

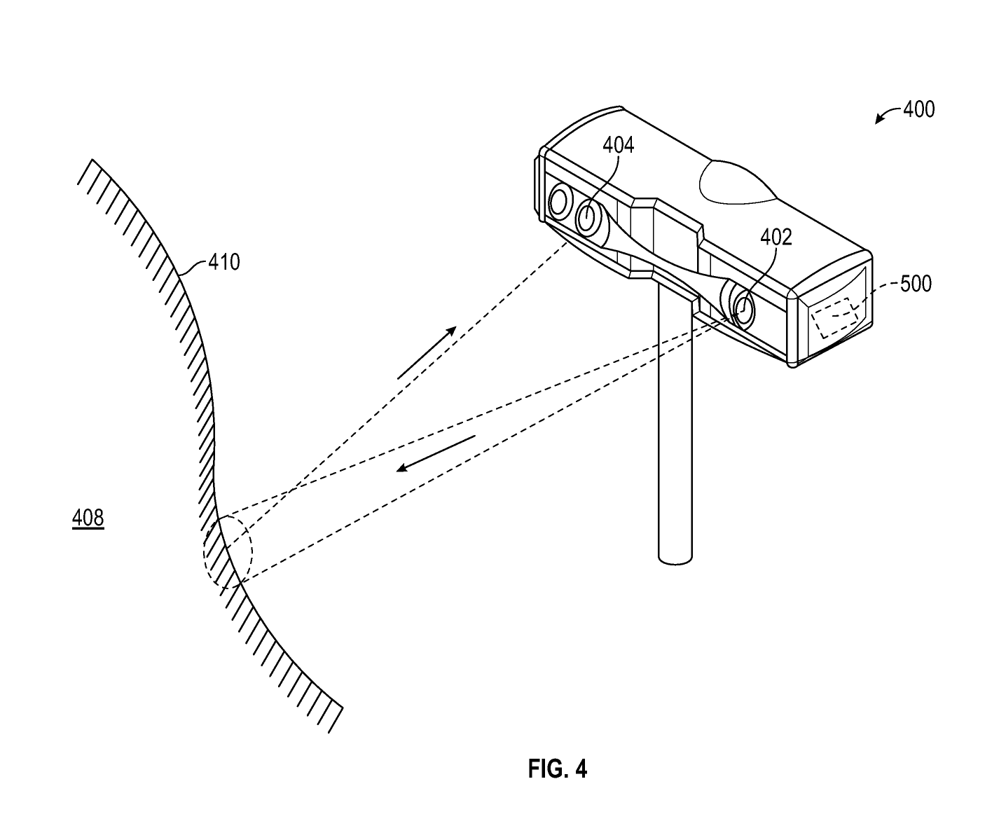

Referring now to FIG. 4, an embodiment of a triangulation scanner 400 is shown that includes a light source 402 and at least one camera 404 and an electronic data processing system 500 that determines the three dimensional coordinates of points on the surface 410 of an object 408. The triangulation scanner may the same as that described in commonly owned U.S. patent application Ser. No. 14/139,021 filed on Dec. 23, 2013, the contents of which are incorporated herein by reference. A triangulation scanner 400 is different than a laser tracker 200 or a TOF laser scanner 300 in that the three-dimensional coordinates are determined based on triangulation principals related to the fixed geometric relationship between the light source 402 and the camera 404 rather than on the speed of light in air.

In general, there are two common types of triangulation scanners 400. The first type, sometimes referred to as a laser line probe or laser line scanner, projects the line or a swept point of light onto the surface 410. The reflected laser light is captured by the camera 404 and in some instances, the coordinates of points on the surface 410 may be determined. The second type, sometimes referred to as a structured light scanner, projects a two-dimensional pattern of light or multiple patterns of light onto the surface. The three-dimensional profile of the surface 410 affects the image of the pattern captured by the photosensitive array 38 within the camera 404. Using information collected from one or more images of the pattern or patterns, the electronic data processing system 406 can in some instances determine a one-to-one correspondence between the pixels of the photosensitive array in camera 404 and the pattern of light emitted by the light source 402. Using this one-to-one correspondence together with a baseline distance between the camera and the projector, triangulation principals are used by electronic data processing system 500 to determine the three-dimensional coordinates of points on the surface 410. By moving the triangulation scanner 400 relative to the surface 410, a point cloud may be created of the entire object 408.

In general, there are two types of structured light patterns, a coded light pattern and an uncoded light pattern. As used herein the term coded light pattern refers to a pattern in which three dimensional coordinates of an illuminated surface of the object are based on single projected pattern and a single corresponding image. With a coded light pattern, there is a way of establishing a one-to-one correspondence between points on the projected pattern and points on the received image based on the pattern itself. Because of this property, it is possible to obtain and register point cloud data while the projecting device is moving relative to the object. One type of coded light pattern contains a set of elements (e.g. geometric shapes) arranged in lines where at least three of the elements are non-collinear. Such pattern elements are recognizable because of their arrangement. In contrast, as used herein, the term uncoded structured light pattern refers to a pattern that does not allow 3D coordinates to be determined based on a single pattern. A series of uncoded light patterns may be projected and imaged sequentially, with the relationship between the sequence of obtained images used to establish a one-to-one correspondence among projected and imaged points. For this embodiment, the triangulation scanner 400 is arranged in fixed position relative to the object 408 until the one-to-one correspondence has been established.

It should be appreciated that the triangulation scanner 400 may use either coded or uncoded structured light patterns. The structured light pattern may include the patterns disclosed in the journal article “DLP-Based Structured Light 3D Imaging Technologies and Applications” by Jason Geng published in the Proceedings of SPIE, Vol. 7932, which is incorporated herein by reference.

Collectively, the metrology instruments such as the AACMM 100, the laser tracker 200, the TOF laser scanner 300 and the triangulation scanner 400 are referred to herein as 3D instruments. It should be appreciated that these metrology instruments are exemplary and the claimed invention should not be so limited, as the systems and methods disclosed herein may be used with any metrology instrument configured to measure three-dimensional coordinates of an object.

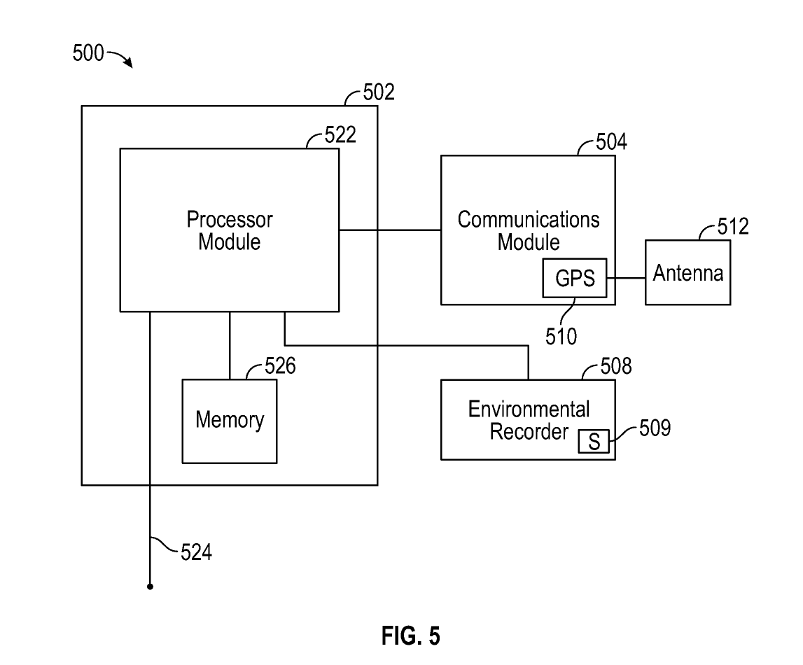

FIG. 5 is a block diagram of an embodiment of an electronic data processing system 500 utilized in 3D instruments 100, 200, 300, 400 in accordance with an embodiment. The electronic data processing system 500 includes a base processor board 502 for implementing the base processing system, a communications module 504 and an environmental recorder 508.

The base processor board 502 includes the various functional blocks illustrated therein. For example, a base processor function 522 is utilized to support the collection of measurement data from the 3D instrument and receives raw metrology data (e.g., encoder system or time of flight data), such as via electrical bus 524. The memory function 526 stores programs and static 3D instrument configuration data. The base processor board 502 may also include an external hardware option port functions for communicating with any external hardware devices or accessories such as but not limited to a graphical monitor or television via HDMI port, an audio device port, a USB 3.0 port and a flash memory (SD) card via one or more ports (not shown) for example.

The base processor board 502 may also manage all the wired and wireless data communication with an external computing device. The base processor board 502 has the capability of communicating with an Ethernet network via a gigabit Ethernet function (e.g., using a clock synchronization standard such as Institute of Electrical and Electronics Engineers (IEEE) 1588), with a wireless local area network via communications module 504. It should be appreciated that the communications module 504 may include other communications related circuits or modules and the modules described herein are exemplary and not intended to be limiting.

The electronic data processing system 500 shown in FIG. 5 also includes an environmental recorder 508 for recording environmental data. The environmental recorder 508 measures and stores data relating to operating and environmental conditions, such as temperature, humidity and shock load data for example. In one embodiment, the environmental recorder 508 may include one or more sensors 509 that are configured to measure environmental conditions. As will be discussed in more detail below, in one embodiment, the environmental recorder 508 cooperates with a geographic location determination circuit, such as GPS module 510 for example, to record the location where a predefined event occurred. The predefined event may be a parameter (e.g. temperature, humidity, shock) exceeding of a threshold, such as a shock load during transit for example. The environmental recorder 508 may further cooperate with other communications circuits within communications module 504 to transmit the event data when a communications medium (e.g. Bluetooth or Wifi) is available.

The communications module 504 may include one or more sub-modules, such as a near field communications circuit (NFC), a cellular teleconference circuit (including LTE, GSM, EDGE, UMTS, HSPA and 3GPP cellular network technologies), a Bluetooth® (IEEE 802.15.1 and its successors) circuit, Wi-Fi (IEEE 802.12) circuit and a Global Positioning Satellite (GPS) system 510 for example. It should be appreciated that while embodiments herein describe the location determination device as being a Global Positioning Satellite system, this is for exemplary purposes and the claimed invention should not be so limited. In other embodiments, the geographic location determination circuit may be a Global Navigation Satellite System (GLONASS), a Galileo position system, an Indian Regional Navigational Satellite System (IRNSS) or a Beidou Navigation Satellite System (BDS) for example. In still other embodiments, the geographic location determination circuit may be a non-satellite based technology, such as a cellular phone communications system that determines location based on triangulation of cellular towers for example. The geographic location determination circuit receives a signal from an external source that may in some instances allow determination of the geographic location of the 3D Instrument. It should be appreciated that the signal from the external source may include a reference time data.

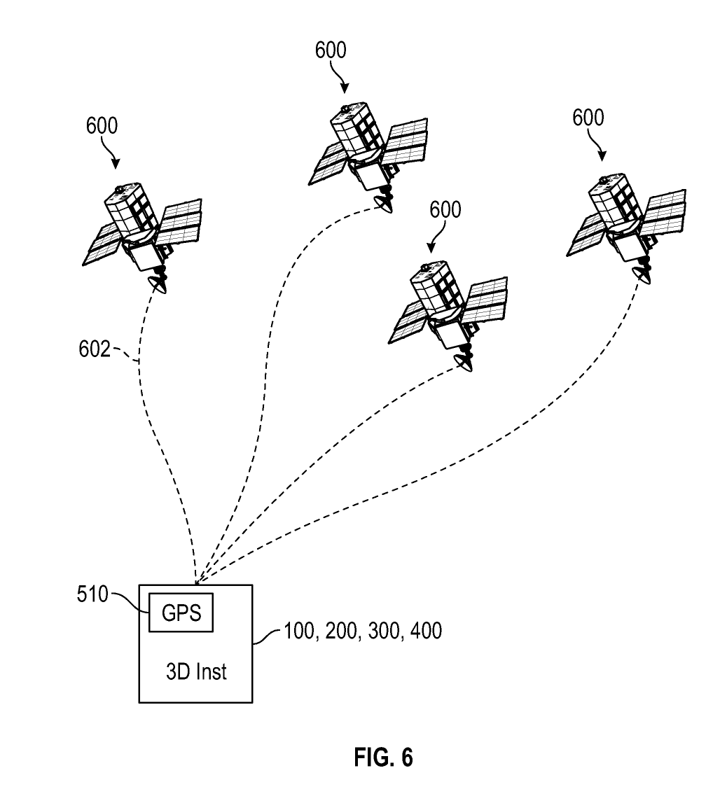

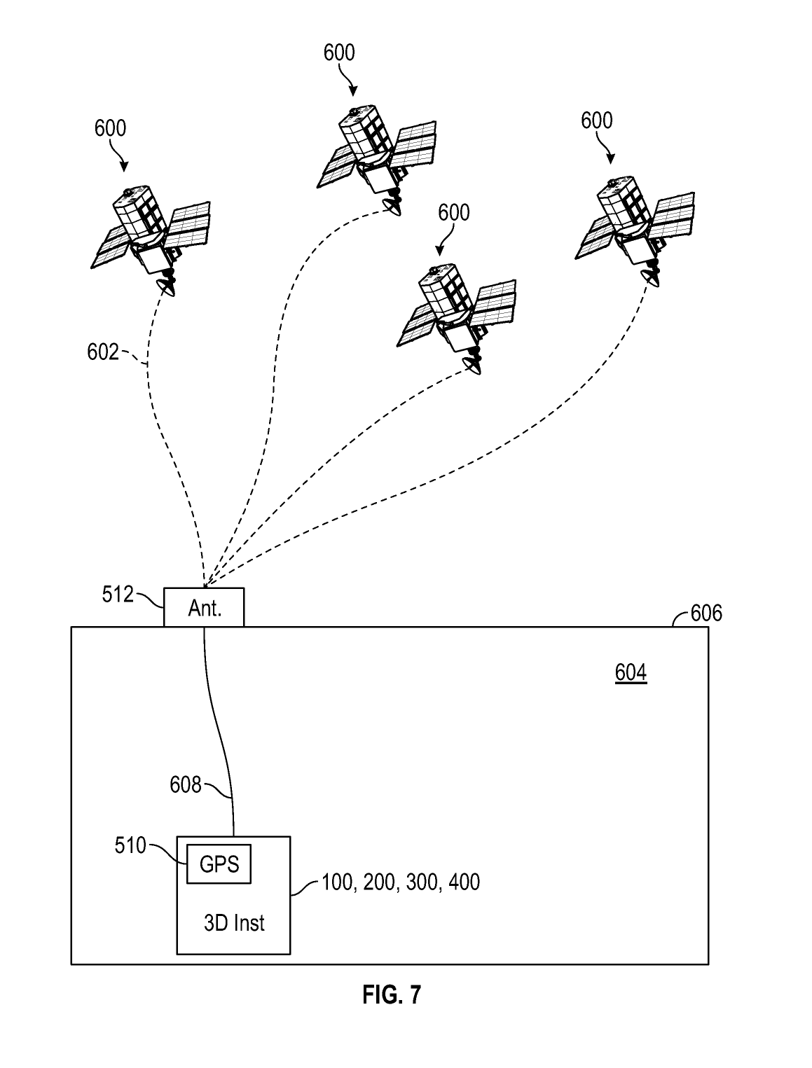

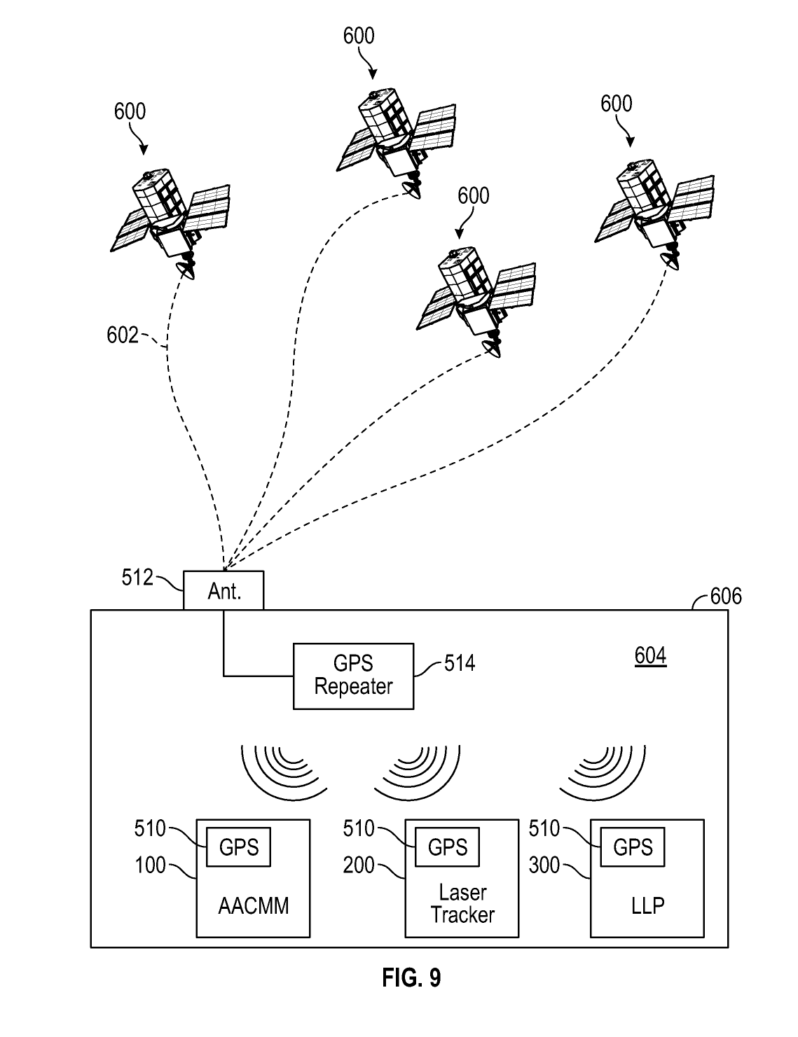

In one embodiment, the GPS Module 510 is connected to an antenna 512. The antenna 512 may be mounted internal to or coupled to the 3D Instrument (FIG. 6). In another embodiment, the antenna 512 may be external or remotely located from the 3D Instrument (FIG. 7). Where the antenna 512 is remotely located, the antenna 512 may be arranged adjacent a window or on a roof of a building for example and connected to the 3D Instrument via a hard-wired connection. In still another embodiment (FIG. 9), the antenna 512 transmits the signal to a GPS repeater 514, which in turn wirelessly transmits the GPS signal to GPS module 510.

Though shown as separate components, in other embodiments all or a subset of the components may be physically located in different locations and/or functions combined in different manners than that shown in FIG. 5. For example, in one embodiment, the base processor board 502 is shielded to reduce radio frequency (RF) interference and the communications module board 504 is disposed outside of the shielding to allow communication with external devices.

Referring now to FIG. 6, an embodiment is shown of the 3D Instrument 100, 200, 300, 400 cooperating with one or more satellites 600. Each satellite 600 transmits radio message signals 602 that include the time the radio message was transmitted and the satellite position at the time of transmission. The GPS module 510 receives the radio messages and determines the transit time of each message and computes the distance to each satellite using the speed of light. The distances and satellite locations are used to determine the location of the receiver using navigation equations as is known in the art. Typically, to accurately determine the 3D Instrument position, the GPS module 510 will receive four or more satellite signals. In one embodiment, the GPS module 510 may determine location using less than four satellites when another parameter is known. In one embodiment, the 3D Instrument includes an altimeter that provides an altitude, to allow the location to be determined with only three satellites. As will be discussed in more detail below, where the GPS module 510 is used for time synchronization, the functions may be performed with a single satellite signal.

It should be appreciated that metrology equipment, such as 3D Instruments 100, 200, 300, 400 for example, may be used within the interior portions 604 of a building 606. In embodiments where the 3D Instrument is not located near a window, it may be difficult to receive a sufficient number of GPS signals 602 to determine geographic location. Referring now to FIG. 7, an embodiment is illustrated within a 3D Instrument located within an interior portion 604 of building 606. In this embodiment, the antenna 512 is mounted remotely from the 3D Instrument, such as next to a window or on the outside of the building 606 (e.g. the roof). When arranged in this manner, the antenna is positioned to receive GPS radio signals from a sufficient number of satellites to determine the geographic location with a desired level of accuracy. The antenna 512 is coupled to the GPS module 510 by a communications line 608. In the exemplary embodiment, the communications line 608 is a hard-wired connection such as coaxial cable. In another embodiment, GPS signals 602 are transmitted wirelessly, such as via Wifi or Bluetooth for example. As will be discussed below, the GPS signals 602 may be transmitted via a GPS repeater. This embodiment provides advantages in allowing the 3D Instrument to be used anywhere within the building 606.

In some embodiments, it is desirable to use multiple 3D instruments together, such as is described in commonly owned U.S. patent application Ser. No. 13/826,584 entitled “System and Method of Acquiring Three Dimensional Coordinates using Multiple Coordinate Measurement Devices” filed on Mar. 14, 2013 or commonly owned U.S. Pat. No. 7,804,602 entitled “Apparatus and Method for Relocating an Articulating-Arm Coordinate Measuring Machine” filed Jun. 23, 2006, the contents of which are incorporated herein by reference. Typically, when multiple metrology units are used together, a first instrument (e.g. the AACMM or a laser scanner) directly measures the objects while another instrument (e.g. a laser tracker) measures the location of the first instrument. The data from the first and second instruments are then matched using a time stamp associated with each coordinate point. In this way dimensions of objects that are too large to measure with a single instrument may be acquired.

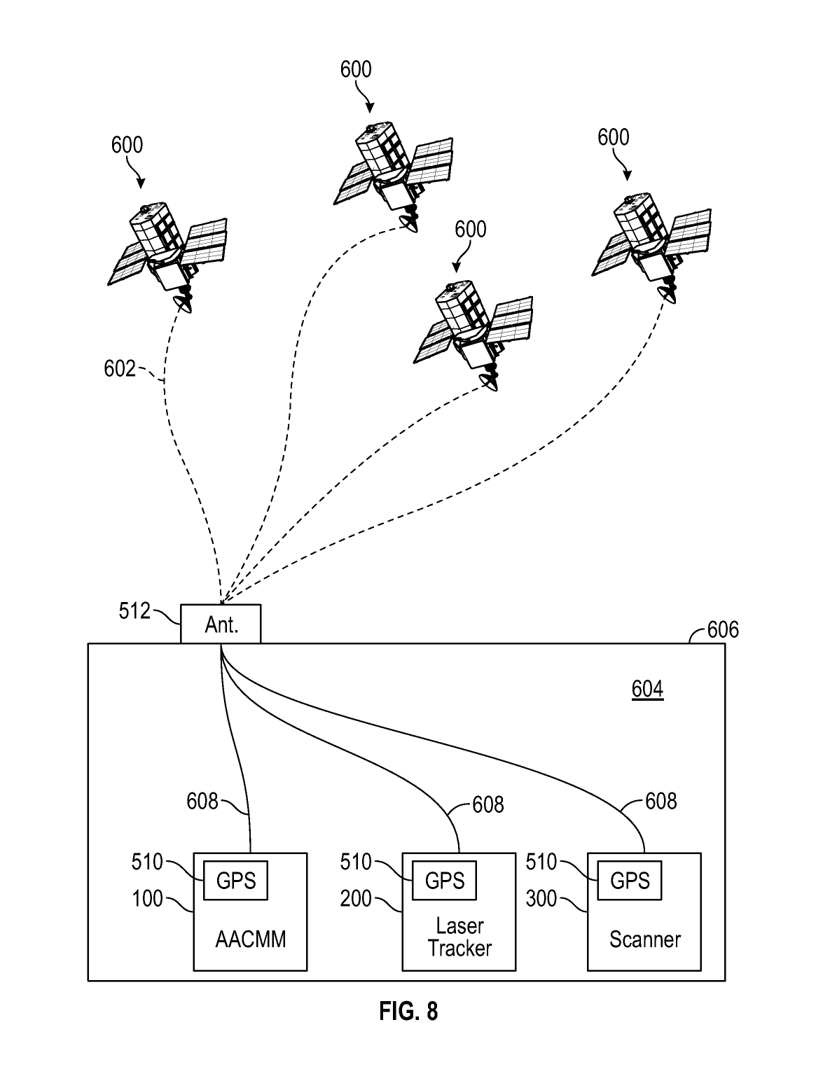

It should be appreciated that since the time stamp of the coordinate data is used to match data acquired by separate instrument, it is desirable to synchronize the internal clocks of each instrument. Referring now to FIG. 8, an embodiment is illustrated having multiple 3D Instruments, such as AACMM 100, a laser tracker 200 and a laser scanner 300 for example.

Each of the 3D Instruments 100, 200, 300 includes a GPS module 510. The GPS modules are coupled to receive signals from antenna 512 via communication lines 608. In this way, each of the 3D Instruments receives the GPS signals. Thus, using this information, each metrology instrument 100, 410, 412 may synchronize its internal clock with the satellite signal. It should be appreciated that with the respective internal clocks synchronized to the same source, the matching of corresponding data sets between the instruments 100, 200, 300 is facilitated and the potential for errors reduced.

In one example, the 3D Instruments are co-located in close proximity. Each GPS module 510 includes its own GPS oscillator, which is a Thermally Compensated Cystal Oscillator (TCXO) having a frequency of 26 MHz and an accuracy of 2.5 ppm. Each receiver provides a pulse per second (PPS) synchronization signal, the edge of which triggers a time stamp. The PPS signal has a PPS jitter of 100 ns, which will not affect the synchronization of the two instruments but will affect the consistency of the time stamp. The accuracy of the TCXO in this embodiment does not affect the accuracy, but the period of the oscillator does, and so the reciprocal of the TCXO frequency (38.5 ns) is added to the PPS jitter to get the consistency of the time stamp. Since it is unknown where in the building 606 the 3D instruments are located, the PPS signals may not remain synchronized between 3D Instruments (since many PPS cycles may have elapsed). However, if the 3D instruments have been averaging readings for 24 hours, the variation in the time stamp is expected to increase by σ_{RC}_{_{—}}_{A}/c, which is 3 ns. Where σ_{RC} is the standard deviation of the error in the GPS receiver position. σ_{RC}=PDOP*σ_{R}. Where PDOP is the Position Dilution of Precision and σ_{R} is the standard deviation of the user equivalent range errors. In addition, individual timekeeping units are expected to vary by 50 ns p-p. As a result, the estimated variability in the time stamp is expected to be 192 ns.

In another example, the TXCO varies +/−30 ppm from −20 to +90° C., corresponding to 0.667 ppm/K. Assuming a temperature drift of 0.05° C. in one second, the drift between the two instruments would then by 0.067 ppm, which is 67 ns/s. Therefore the variation in the time stamp over a 1 second interval, then the variation in the time stamp for this case is 192 ns+67 ns=259 ns.

In still another example, the 3D Instruments are separated by a distance of 50 meters. This corresponds to a propagation time for light of 168 ns. The propagation time may then be added to the variation in the time stamp. Using the examples from above, this would result in a worst case variation of about 400 ns. Further, since the time delay based on the distance between the 3D Instrument and the antenna is accounted for, the GPS readings do not need to be averaged for 24 hours.

In the exemplary embodiment, the synchronization of 3D Instruments using the GPS signals is sufficiently accurate for the measurements to be made in most applications. If the 3D instrument is attempting measure an object moving at 1 meter per second with an error of less than 2 micrometers, the synchronization will need to be less than or equal to 2 micrometers/1 meter per second=2 microseconds. Therefore, in the first example, the synchronization is accurate enough if the signals have been averaged for at least 24 hours. In the second example, the 24 hour averaging period is not needed provided that the 3D Instruments are not separated by more than 50 meters.

In some applications, it may be impractical or undesirable to connect each of the 3D Instruments 100, 200, 300, 400 to the antenna 512. In these embodiments a GPS repeater 514 is coupled to an antenna 512 that is located to receive signals from the GPS satellites 600. A GPS repeater 514 is a device that retransmits the GPS signals received via antenna 512 to allow the 3D instruments (and any other GPS devices within the interior portion 604 of facility 606). In the exemplary embodiment, the GPS repeater is connected to the antenna by a coaxial cable. It should be appreciated that while embodiments herein describe a single GPS repeater 514, multiple repeaters may operate within a facility 606, such as when the 3D instruments are not located within the same space 604, or the space is too large (e.g. an aircraft hangar) for coverage by a single repeater unit.

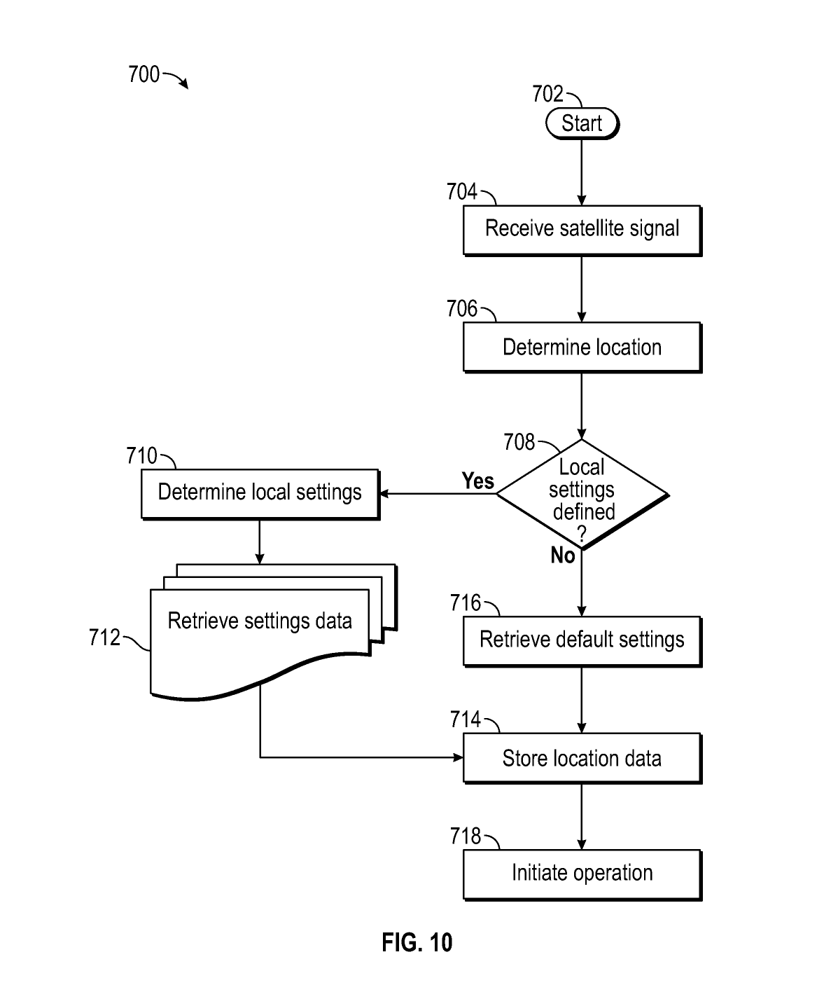

It should be appreciated that the incorporation of a GPS device 510 in a 3D Instrument provides functionality in addition to the synchronization of multiple instruments described above. Referring now to FIG. 10, a method 700 is illustrated of configuring localized settings using data from the GPS device 510. It is not uncommon for devices, such as 3D instruments for example, to be configured differently in different geographic locations. For example, to comply with local regulations the wireless networking circuits (e.g. Wifi) may have to operate on different frequencies and/or different power levels. These localization settings may also include language settings for example. To accommodate these changes, a manufacturer may configure the device during assembly, resulting in additional inventory. In other instances, the device may be configured during installation or by the end user, causing delays in operation or the possibility of noncompliant operation.

In one embodiment, the localization of the 3D Instrument may be performed automatically upon initialization of the 3D Instrument operation. The method 700 starts in block 702 and proceeds to block 704 where the GPS signal is received. The method 700 determines in block 706 the geographic location (e.g. United States, Japan, Australia, etc.) of the 3D Instrument. In block 708, it is determined whether the local settings are for the geographic location identified in block 706 has been defined. If query block 708 returns a positive, the method 700 proceeds to block 710 where the local settings are determined and retrieved in block 712. The method 700 then proceeds to store the location settings data in memory for use during operations in block 714. If the query block 708 returns a negative, the method 700 retrieves default settings in block 716 before storing them in memory in block 714. Once the settings are stored, the 3D Instrument initiates operation in block 718.

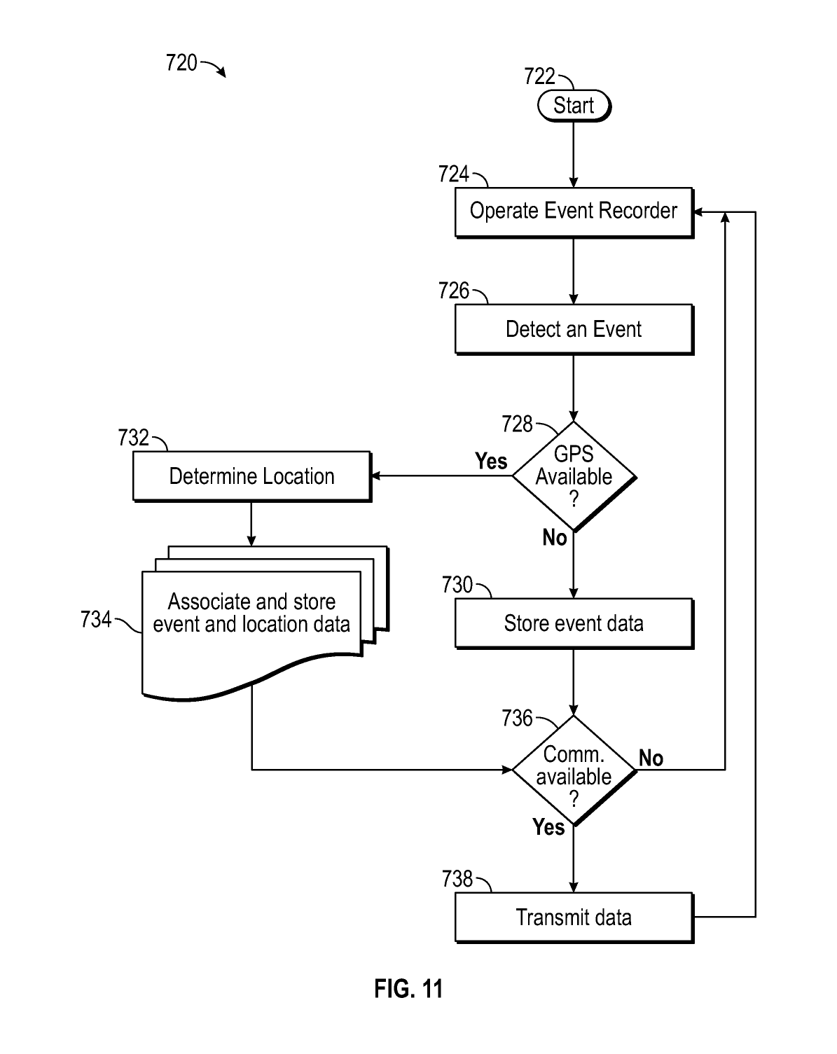

Referring now to FIG. 11, another method 720 is illustrated for using location data to record events, such as shock loading for example, and associate the event with a location and time. The method 720 starts in block 722 and proceeds to block 724 where an event recorder 724 is operated to detect predetermined events. The events may include, but are not limited to: shock loading above a threshold, temperatures humidity or vibration exceeding or falling below thresholds. In block 726, an event is detected and the method 720 proceeds to query block 728 where it is determined whether a GPS signal is available. It should be appreciated that a GPS signal may not always be available, such as when the 3D Instrument is in a crate during transport for example. If query block 728 returns a negative, the method proceeds to block 730 where the event data is stored.

If the query block 728 returns a positive, the method 720 proceeds to block 732 where the location is determined from the GPS signals and the event and location are associated in block 734. Once the data is stored, the method 720 proceeds to query block 736 where it is determined whether communications is available, such as via Ethernet, Wifi or Bluetooth for example. If the query block 736 returns a negative, the method 720 loops back to block 724. If the query block 736 returns a positive, the data is transmitted in block 738 and the method loops back to block 724.

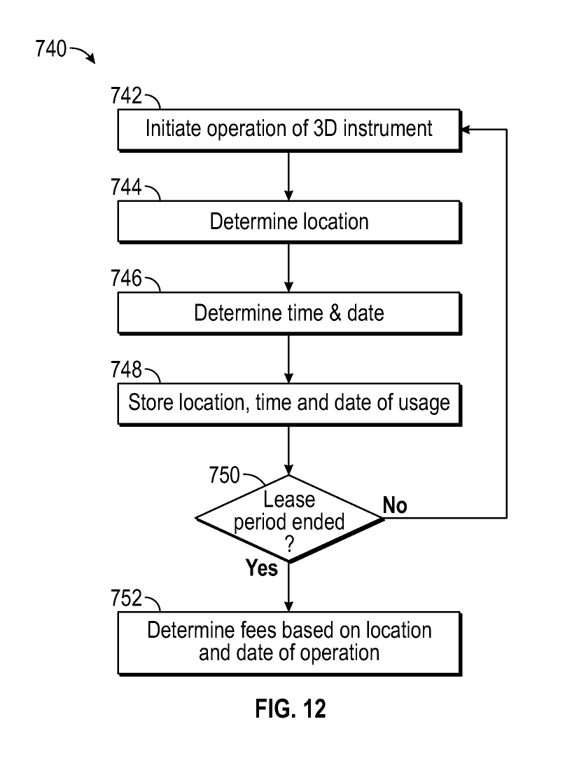

Location data may further be used to determine an amount owed on a lease of the 3D Instrument. In some embodiments, the 3D Instrument may be leased to an end user. The amount paid by the end user could change if the end user moves the 3D Instrument from one geographic area to another, such as if the 3D Instrument is moved from the United States to Canada or Mexico for example. Referring now to FIG. 12, a method 740 is illustrated for determining a lease amount based on location of usage. The method starts in block 742 where the operation of the 3D Instrument is initiated. The method 740 then proceeds to block 744 where the location of the 3D Instrument is determined. The date and time of the operation of the 3D Instrument is determined in block 746 and the location, date and time data is stored in block 748.

The method 740 then proceeds to block 750 where it is determined whether the lease period has expired. If the query block 750 returns a negative, the method 740 loops back to block 742. If query block 750 returns a positive, the method 740 proceeds to block 752 where the fees for the lease are determined based on the location and date of operation. It should be appreciated that the expiration of the lease period may be when the 3D Instrument is returned to the owner, or may be on a more frequent basis. For example, the determination of fees may be determined on a daily, weekly, monthly or quarterly basis. In these embodiment, the 3D Instrument may be configured to communicate the location and date data on a periodic or aperiodic basis to allow updates/changes in the lease amount. In one embodiment, the 3D Instrument communicates with a remote server of the owner when the instrument is moved from one geographic location to another.

Technical effects and benefits include the determination of a location of a metrology instrument. Further technical effects and benefits include the synchronizing of multiple 3D Instrument clocks to a GPS signal to allow coordinated operation of the 3D Instruments. Further technical effects and benefits include the customizing the settings and operation of a 3D Instrument based on the geographic location of the 3D Instrument. Further technical effects and benefits include monitoring and recording of predetermined events and associating the event with a geographic location. Still further technical effects and benefits include the monitoring and recording of the location of operation of the 3D Instrument to determine lease fees due.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for measuring three-dimensional (3D) coordinates of an object comprising:
a first metrology instrument for measuring a first set of 3D coordinates of at least one point on a surface of the object in a local coordinate system frame of reference, the first metrology instrument having a first processor and a first system clock, wherein the first processor is configured in operation to synchronize the first system clock with a signal from an external source, wherein the signal includes at least a reference time data;
a second metrology instrument for measuring a second set of 3D coordinates of at least one point on the first metrology instrument in a second coordinate system frame of reference, the second metrology instrument having a second processor and a second system clock, wherein the second processor is configured in operation to synchronize the second system clock with the signal from the external source; and
a controller operably coupled for communication to the first metrology instrument and the second metrology instrument, the controller including a processor responsive to executable computer instructions for determining a third set of 3D coordinates in the second coordinate system frame of reference of the at least one point on the object based at least in part on the first set of 3D coordinates and the second set of 3D coordinates.

2. The system of claim 1 wherein:
the first metrology device further includes a first geographic location determination circuit, the first geographic location determination circuit configured in operation to receive the signal from the external source; and
the second metrology device further includes a second geographic location determination circuit, the second geographic location determination circuit configured in operation to receive the signal from the external source.

3. The system of claim 2 further comprising an antenna positioned to receive the signal, the antenna being coupled for communication to the first geographic location determination circuit and the second geographic location determination circuit.

4. The system of claim 3 wherein the first geographic location determination circuit and the second geographic location determination circuit are each a Global Positioning Satellite circuit.

5. The system of claim 2 wherein the first geographic location determination circuit includes an oscillator having a frequency and an accuracy, the oscillator being configured to generate a synchronization signal having a predetermined jitter parameter, and the first processor is further responsive to executable instructions to determine a consistency value of the synchronization signal and averaging the consistency value over a 24 hour time period.

6. The system of claim 5 wherein the consistency value is equal to a reciprocal of the frequency plus the predetermined jitter value.

7. The system of claim 2 wherein the first metrology instrument and the second metrology instrument are separated by a distance less than or equal to a predetermined value such that the variation in time data between the first metrology instrument and the second metrology instrument is less than or equal to 400 ns.

8. The system of claim 2 wherein the external source is an antenna arranged to receive signals from a global positioning satellite system.

9. The system of claim 2 wherein the external source is a global positioning satellite system repeater configured to receive a GPS signal from a global positioning satellite system and transmit the signal.

10. A method of measuring 3D coordinates of an object with multiple metrology devices, the method comprising:
providing a first metrology instrument for measuring a first set of 3D coordinates of at least one point on a surface of the object, the first metrology instrument having a first processor, a first geographic location determination circuit and a first system clock;
a second metrology instrument for measuring a second set of 3D coordinates of at least one point on the first metrology instrument, the second metrology instrument having a second processor, a second geographic location determination circuit and a second system clock;
receiving with the first geographic location determination circuit a first signal from an external source;
receiving with the second geographic location determination circuit the first signal from the external source;
synchronizing the first system clock and the second system clock based at least in part on the signal;
measuring with the first metrology instrument a first set of 3D coordinates of at least one point on the object in a local coordinate system frame of reference at a first time;
measuring with the second metrology instrument a second set of 3D coordinates of at least one point on the first metrology instrument in a second coordinate system frame of reference at a second time; and
determining a third set of 3D coordinates of the at least one point on the object in the second coordinate system frame of reference based at least in part on the first set of 3D coordinates, the second set of 3D coordinates, the first time and the second time.

11. The method of claim 10 wherein the external source is an antenna positioned to receive a signal from a global positioning satellite system, the antenna being coupled for communication to the first geographic location determination circuit and the second geographic location determination circuit.

12. The method of claim 10 wherein the external source is a global positioning system configured to receive a signal from a global positioning satellite system and transmit the first signal.

13. The method of claim 10 further comprising:
generating a synchronization signal with the first geographic location determination circuit, the synchronization signal having a predetermined jitter parameter;
determining a consistency value of the synchronization signal; and
averaging the consistency value over a 24 hour time period.

14. The method of claim 13 wherein the consistency value is equal to a reciprocal of the frequency plus the predetermined jitter value.

15. The method of claim 10 further comprising separating the first metrology instrument and the second metrology instrument by a distance less than or equal to a predetermined value such that the variation in time data between the first metrology instrument and the second metrology instrument is less than or equal to 400 ns.

16. A method of configuring a 3D metrology instrument comprising:
receiving a signal from an external source, the signal including data indicating a geographic location of the 3D metrology instrument;
determining the geographic location of the 3D metrology instrument based on the signal;
determining when localized setting parameters are defined for the geographic location;
retrieving the localized setting parameters from memory; and
changing the operation of the 3D metrology device instrument based on the localized setting parameters.

17. The method of claim 16 further comprising storing the location data in memory.

18. The method of claim 16 further comprising retrieving a default setting parameters when the geographic location is not determined.

19. The method of claim 18 further comprising changing the operation of the 3D metrology device instrument based on the default setting parameters.

20. A method of monitoring a 3D metrology instrument for predetermined events comprising:
providing a 3D metrology instrument having at least one sensor configured to measure an environmental condition the 3D metrology instrument having a geographic location determination circuit, a processor and memory;
measuring a predetermined event data with the sensor;
determining the geographic location data of the 3D metrology instrument with the geographic location determination circuit in response to measuring the predetermined event data; and
storing in the memory the measured predetermined event data and the location data of the 3D metrology instrument.

21. The method of claim 20 further comprising determining if an external communications medium is available.

22. The method of claim 21 further comprising transmitting the measured predetermined event data and location data to a remote computer when an external communications medium is available.

23. The method of claim 22 further comprising storing the measured predetermined event when the geographic location data is not determined.
